(19) United States
(12) Patent Application Publication
(10) Pub. No.: US 2023/0062338 A1
(43) Pub. Date: Mar. 2, 2023

(54) OPTICAL UNIT AND METHOD FOR MANUFACTURING OPTICAL UNIT

(71) Applicant: NIDEC CORPORATION, Kyoto (JP)

(72) Inventors: Takayuki IWASE, Kyoto (JP); Tomohiro EGAWA, Kyoto (JP); Genki TANAKA, Kyoto (JP)

(21) Appl. No.: 17/894,157

(22) Filed: Aug. 24, 2022

(30) Foreign Application Priority Data
Aug. 25, 2021 (JP) 2021-137507

(51) Int. Cl. G03B 5/06; G03B 17/17

(52) U.S. Cl. CPC G03B 5/06; G03B 17/17; G03B 2205/0069; G03B 2205/003

(57) ABSTRACT

An optical unit includes a movable body, a support body, a swing mechanism, a magnet, and a magnetic member. The movable body includes an optical element that changes a traveling direction of light. The support body supports the movable body swingably about a swing axis. The swing mechanism swings the movable body about the swing axis. The magnet is disposed on one of the movable body and the support body. The magnetic member is disposed on the other of the movable body and the support body. The magnet and the magnetic member overlap each other as viewed from a direction in which the support body supports the movable body. At least one of the movable body and the support body includes a covering unit disposed between the magnet and the magnetic member, and the covering unit covers at least a part of a contour of one of the magnet and the magnetic member.

### CROSS-REFERENCE TO RELATED APPLICATIONS

The present invention claims priority under 35 U.S.C. § 119 to Japanese Patent Application No. 2021-137507 filed on Aug. 25, 2021, the entire content of which is incorporated herein by reference.

### FIELD OF THE INVENTION

The present disclosure relates to an optical unit and a method for manufacturing the optical unit.

### BACKGROUND

Image blur may be generated due to camera shake during capturing a still image or a moving image with a camera. A camera shake correction device enabling the capturing of a clear image by preventing the image blur has been put into practical use.

Conventionally, a reflection module including a reflection member, a holder, and a first housing is described. The reflection member is attached to the holder. The first housing accommodates the holder. The holder freely rotates relative to a first axis and a second axis within the first housing. In addition, a first yoke and a magnet that are magnetically attracted to each other are disposed on opposing surfaces of the holder and the first housing. The first yoke is provided as a magnetic material. The magnet is attached to a surface of the holder. The first yoke is attached to a surface of the first housing.

By the way, in the conventional reflection module, the magnet is usually attached to the surface of the holder using an adhesive. Usually, the yoke is attached to the surface of the housing using the adhesive.

However, when the magnet and the yoke are bonded to the surfaces of the holder and the housing using the adhesive, the magnet and the yoke may be peeled off from the surfaces of the holder and the housing or may deviate from the bonded positions.

### SUMMARY

An exemplary optical unit according to the present disclosure includes a movable body, a support body, a swing mechanism, a magnet, and a magnetic member. The movable body includes an optical element that changes a traveling direction of light. The support body supports the movable body swingably about a swing axis. The swing mechanism swings the movable body about the swing axis. The magnet is disposed on one of the movable body and the support body. The magnetic member is disposed on the other of the movable body and the support body. The magnet and the magnetic member overlap each other. At least one of the movable body and the support body includes a covering unit disposed between the magnet and the magnetic member, and the covering unit covers at least a part of a contour of one of the magnet and the magnetic member.

Another exemplary method for manufacturing an optical unit according to the present disclosure is a method for manufacturing an optical unit including a movable body, a support body, a swing mechanism, a magnet, and a magnetic member. The movable body includes an optical element that changes a traveling direction of light. The support body supports the movable body swingably about a swing axis. The swing mechanism swings the movable body about the swing axis. The magnet is disposed on one of the movable body and the support body. The magnetic member is disposed on the other of the movable body and the support body. The magnet and the magnetic member overlap each other. The method for manufacturing the optical unit includes a step of disposing the magnet or the magnetic member in a mold, a step of injecting resin into the mold to mold at least one of the movable body and the support body, and a step of supporting the movable body by the support body. In the molding step, at least one of the movable body and the support body includes a covering unit that covers at least a part of a contour of the magnet and the magnetic member. In the supporting step, the covering unit is disposed between the magnet and the magnetic member.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a smartphone including an optical unit according to an embodiment of the present disclosure;

FIG. 2 is a perspective view illustrating the optical unit of the embodiment;

FIG. 3 is an exploded perspective view illustrating the optical unit of the embodiment in which the optical unit is separated into a movable body and a support body;

FIG. 4 is an exploded perspective view illustrating the movable body of the optical unit of the embodiment;

FIG. 5A is a sectional view taken along a line VA-VA in FIG. 2;

FIG. 5B is a sectional view taken along a line VB-VB in FIG. 2;

FIG. 5C is a sectional view taken along a line VC-VC in FIG. 2;

FIG. 5D is a sectional view taken along a line VD-VD in FIG. 2;

FIG. 6 is an exploded perspective view illustrating an optical element and a holder of the optical unit of the embodiment;

FIG. 7 is an exploded perspective view illustrating the optical element, the holder, and a preload unit of the optical unit of the embodiment;

FIG. 8 is an exploded perspective view illustrating the optical element, the holder, the preload unit, a first support, and a second magnet of the optical unit of the embodiment;

FIG. 9 is a perspective view illustrating the movable body of the optical unit of the embodiment;

FIG. 10 is a view illustrating the first support of the optical unit of the embodiment as viewed from one side X1 in a first direction X;

FIG. 11 is an exploded perspective view illustrating the support body of the optical unit of the embodiment;

FIG. 12 is a perspective view illustrating a periphery of a second support in the optical unit of the embodiment;

FIG. 13 is a view illustrating the second support of the optical unit of the embodiment as viewed from the other side X2 in the first direction X;

FIG. 14 is a sectional view illustrating a structure of an optical unit according to a first modification of the embodiment;

FIG. 15 is a schematic sectional view illustrating a method for manufacturing a first support in the optical unit of the first modification of the embodiment;

FIG. 16 is a sectional view illustrating a structure of an optical unit according to a second modification of the embodiment;

FIG. 17 is a sectional view illustrating a structure of an optical unit according to a third modification of the embodiment; and

FIG. 18 is a sectional view illustrating a structure of an optical unit according to a fourth modification of the embodiment.

### DETAILED DESCRIPTION

With reference to the drawings, an exemplary embodiment of the present disclosure will be described below. In the drawings, the same or corresponding parts are given the same reference signs and description thereof will not be repeated.

In the present specification, a first direction X, a second direction Y, and a third direction Z intersecting each other are appropriately described for easy understanding. In the present description, the first direction X, the second direction Y, and the third direction Z are orthogonal to one another, but are not necessarily orthogonal to one another. One side in the first direction is referred to as one side X1 in the first direction X, and the other side in the first direction is referred to as the other side X2 in the first direction X. One side in the second direction is referred to as one side Y1 in the second direction Y, and the other side in the second direction is referred to as the other side Y2 in the second direction Y. One side in the third direction is referred to as one side Z1 in the third direction Z, and the other side in the third direction is referred to as the other side Z2 in the third direction Z. For convenience, the first direction X is sometimes described as an up-down direction. One side X1 in the first direction X corresponds to a lower side, and the other side X2 in the first direction X corresponds to an upper side. However, the up-down direction, the upward direction, and the lower direction are defined for convenience of the description, and do not necessarily coincide with the vertical direction. The up-down direction is defined just for convenience of the description, and does not limit an orientation during use and assembly of the optical unit of the present disclosure.

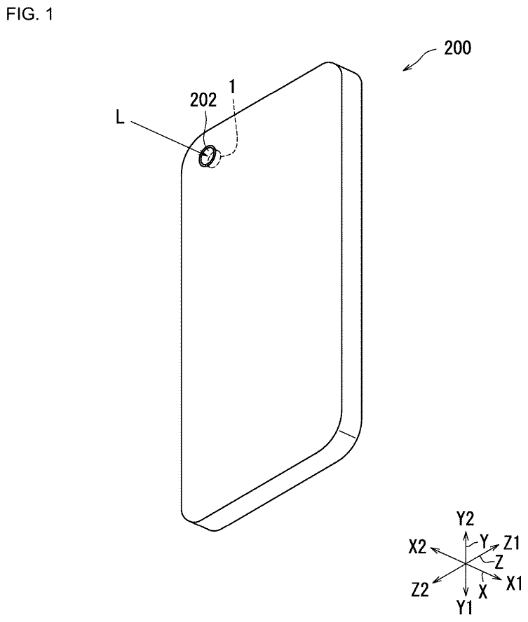

With reference to FIG. 1, an example of application of an optical unit 1 will be described. FIG. 1 is a perspective view schematically illustrating a smartphone 200 including the optical unit 1 according to an embodiment of the present disclosure. The smartphone 200 includes the optical unit 1. The optical unit 1 reflects incident light in a certain direction. As illustrated in FIG. 1, the optical unit 1 is suitably used as, for example, an optical component of the smartphone 200. The application of the optical unit 1 is not limited to the smartphone 200, and can be used for various devices such as a digital camera and a video camera.

The smartphone 200 includes a lens 202 on which light is incident. In the smartphone 200, the optical unit 1 is disposed inside the lens 202. When light L enters the inside of the smartphone 200 through the lens 202, a traveling direction of the light L is changed by the optical unit 1. The light L is imaged by an imaging element (not illustrated) through a lens unit (not illustrated).

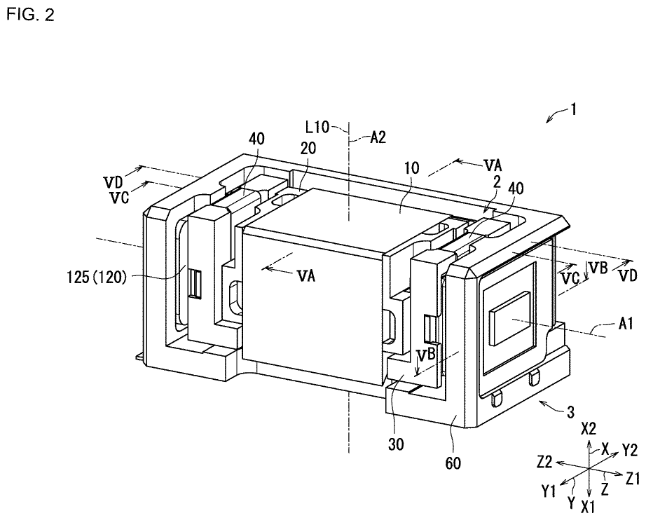

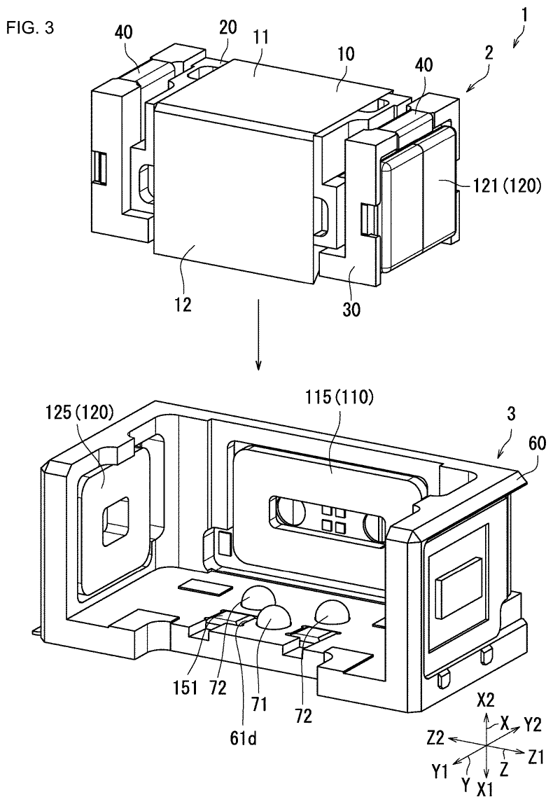

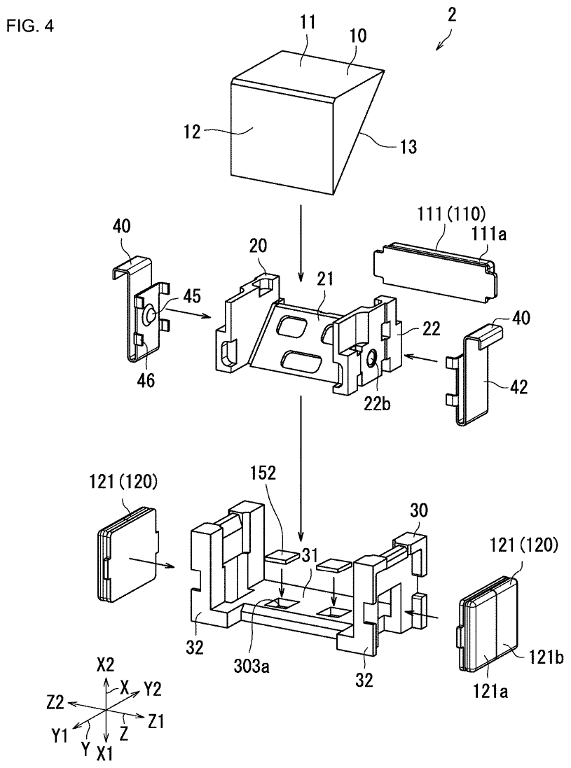

With reference to FIGS. 2 to 13, the optical unit 1 will be described below. FIG. 2 is a perspective view illustrating the optical unit 1 of the embodiment. FIG. 3 is an exploded perspective view illustrating the optical unit 1 of the embodiment in which the optical unit 1 is separated into a movable body 2 and a support body 3. As illustrated in FIGS. 2 and 3, the optical unit 1 includes at least the movable body 2, the support body 3, and a second swing mechanism 120. In the embodiment, the optical unit 1 includes a magnet 151 and a magnetic member 152 (FIG. 4). In the embodiment, the optical unit 1 further includes a first swing mechanism 110. In the embodiment, the optical unit 1 further includes a preload unit 40. The second swing mechanism 120 is an example of the “swing mechanism” of the present disclosure. The details will be described below.

FIG. 4 is an exploded perspective view illustrating the movable body 2 of the optical unit 1 of the embodiment. As illustrated in FIGS. 2 to 4, the optical unit 1 includes the movable body 2 and the support body 3. The support body 3 supports the movable body 2 swingably about a second swing axis A2. The second swing axis A2 is an example of the “swing axis” of the present disclosure.

The movable body 2 includes an optical element 10. The movable body 2 includes a holder 20 and a first support 30. The movable body 2 includes the preload unit 40. The optical element 10 changes the traveling direction of light. The holder 20 holds the optical element 10. The first support 30 supports the holder 20 and the optical element 10 swingably about a first swing axis A1 that intersects the second swing axis A2. The first support 30 is supported by the support body 3 swingably about the second swing axis A2. More specifically, the first support 30 is supported by a second support 60 of the support body 3 swingably about the second swing axis A2.

That is, the holder 20 is swingable with respect to the first support 30, and the first support 30 is swingable with respect to the second support 60. Accordingly, the optical element 10 can be swung about each of the first swing axis A1 and the second swing axis A2, so that an attitude of the optical element 10 can be corrected about each of the first swing axis A1 and the second swing axis A2. Consequently, the image blur can be prevented in two directions. As a result, correction accuracy can be improved as compared with the case in which the optical element 10 is swung about only one swing axis. The first swing axis A1 is also referred to as a pitching axis. The second swing axis A2 is also referred to as a roll axis.

In the embodiment, as described above, the first support 30 supports the holder 20 and the optical element 10. The first support 30 is supported by the second support 60. That is, the holder 20 and the optical element 10 are indirectly supported by the second support 60 of the support body 3 through the first support 30. The holder 20 and the optical element 10 may be directly supported by the second support 60 of the support body 3 without the first support 30. That is, the movable body 2 may not include the first support 30.

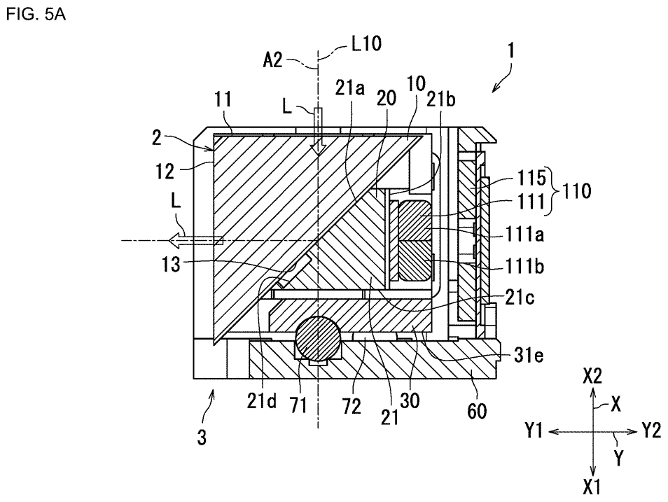

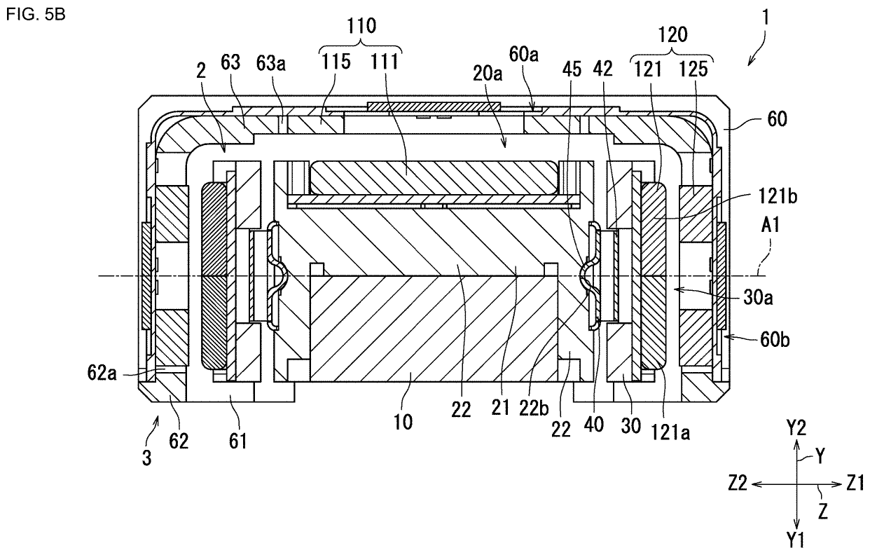

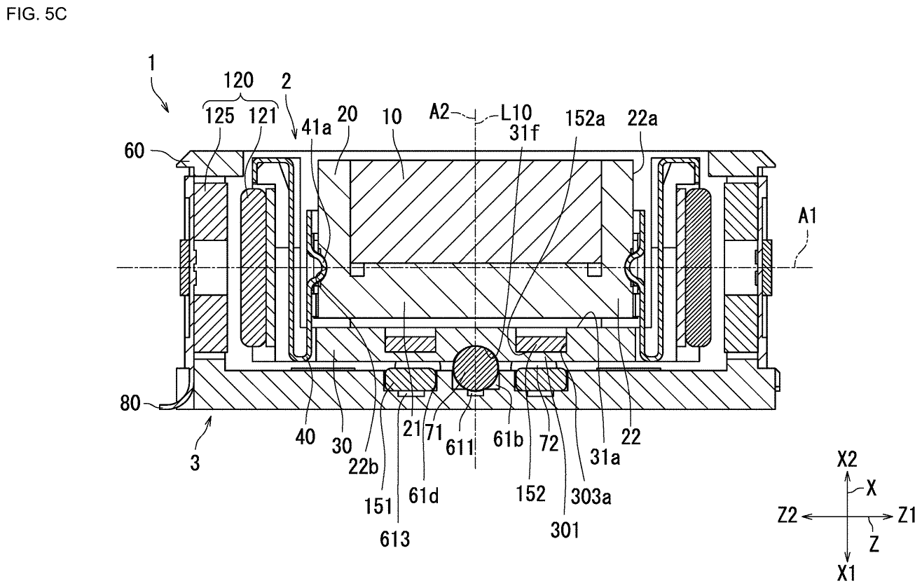

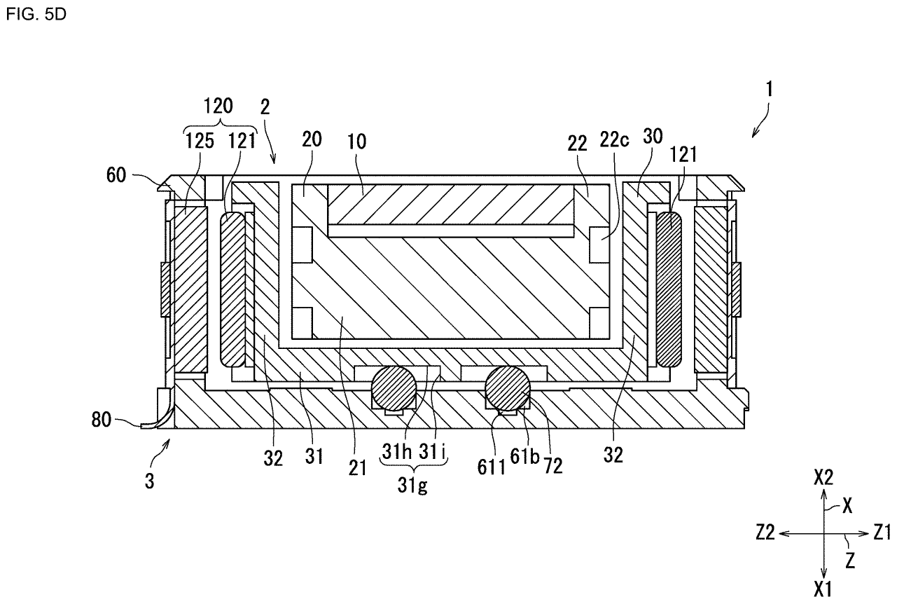

The first swing axis A1 is an axis extending along the third direction Z intersecting the first direction X and the second direction Y. The second swing axis A2 is an axis extending along the first direction X. Accordingly, the optical element 10 can be swung about the first swing axis A1 intersecting the first direction X and the second direction Y. The optical element 10 can be swung about the second swing axis A2 extending along the first direction X. Consequently, the attitude of the optical element 10 can be appropriately corrected. The first direction X and the second direction Y are directions along the traveling direction of the light L (FIG. 5A). That is, the optical element 10 can be swung about the first swing axis A1 intersecting the first direction X and the second direction Y that are the traveling direction of light. Accordingly, the attitude of the optical element 10 can be corrected more appropriately.

The first support 30 supports the holder 20 in the third direction Z. Accordingly, the first support 30 can be easily swung about the first swing axis A1 extending along the third direction Z. Specifically, in the embodiment, the first support 30 supports the holder 20 in the third direction Z through the preload unit 40.

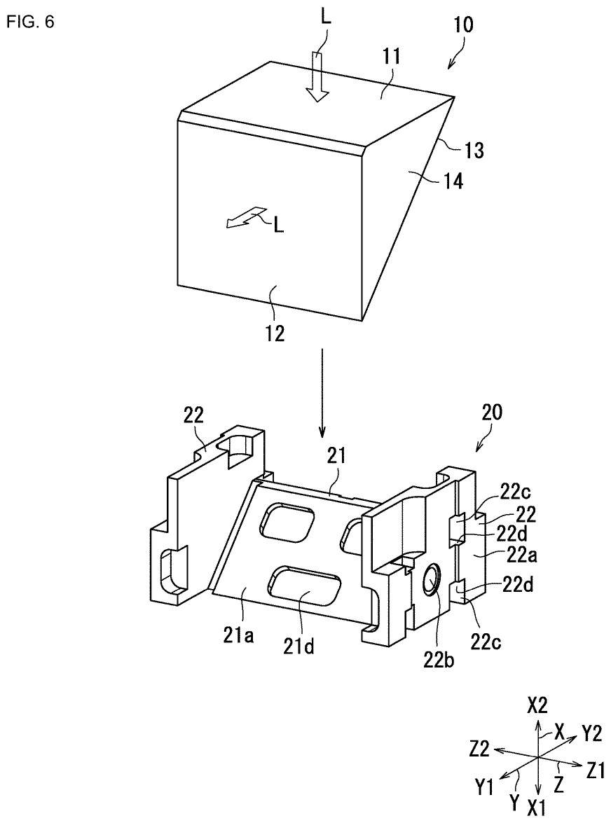

FIG. 5A is a sectional view taken along a line VA-VA in FIG. 2. FIG. 5B is a sectional view taken along a line VB-VB in FIG. 2. FIG. 5C is a sectional view taken along a line VC-VC in FIG. 2. FIG. 5D is a sectional view taken along a line VD-VD in FIG. 2. FIG. 6 is an exploded perspective view illustrating the optical element 10 and the holder 20 of the optical unit 1 of the embodiment. As illustrated in FIGS. 5A to 5D and 6, the optical element 10 is configured of a prism. The prism is made of a transparent material that has a higher refractive index than air. For example, the optical element 10 may be a plate-shaped mirror. In the embodiment, the optical element 10 has a substantially triangular prism shape. Specifically, the optical element 10 includes a light incident surface 11, a light emission surface 12, a reflection surface 13, and a pair of side surfaces 14. The light L is incident on the light incident surface 11. The light emission surface 12 is connected to the light incident surface 11. The light emission surface 12 is disposed perpendicular to the light incident surface 11. The reflection surface 13 is connected to the light incident surface 11 and the light emission surface 12. The reflection surface 13 is inclined by about 45 degrees with respect to each of the light incident surface 11 and the light emission surface 12. That is, the reflection surface 13 reflects the light L traveling to one side X1 in the first direction X to one side Y1 in the second direction Y intersecting the first direction X. That is, the optical element 10 reflects the light L traveling to one side X1 in the first direction X to one side Y1 in the second direction Y intersecting the first direction X. The pair of side surfaces 14 are connected to the light incident surface 11, the light emission surface 12, and the reflection surface 13.

An optical axis L10 of the optical element 10 and the second swing axis A2 are disposed to overlap each other. In the present description, the optical axis L10 of the optical element 10 means an axis that coincides with at least any of an axis that is perpendicular to the light incident surface 11 of the optical element 10 and passes through the center of the reflection surface 13, a light axis of the lens 202 on which light is incident, an axis that passes through an intersection between the optical axis of the lens unit existing at the reflection destination and the reflection surface 13 and extends in the direction perpendicular to the optical axis of the lens unit, and an axis that passes through an intersection between a straight line passing through the center of the imaging element and the reflection surface 13 and extends in the direction perpendicular to a straight line passing through the imaging element. Typically, all the axis that is perpendicular to the light incident surface 11 of the optical element 10 and passes through the center of the reflection surface 13, the light axis of the lens 202 on which the light is incident, the axis that passes through an intersection between the optical axis of the lens unit present at the reflection destination and the reflection surface 13 and extends in the direction perpendicular to the optical axis of the lens unit, and the axis that passes through the intersection between the straight line passing through the center of the imaging element and the reflection surface 13 and extends in the direction perpendicular to the straight line passing through the imaging element coincide with one another.

At least one of the holder 20 and the first support 30 includes a recess recessed on the side opposite to the preload unit 40 or a protrusion protruding toward the preload unit 40. In the embodiment, the holder 20 includes an axial recess 22b that is recessed on the side opposite to the preload unit 40.

Specifically, for example, the holder 20 is made of resin. The holder 20 includes a holder body 21 and a pair of side surface units 22. The holder 20 includes a pair of opposing side surfaces 22a and the axial recess 22b.

The holder body 21 extends in the third direction Z. The holder body 21 includes a support surface 21a and a plurality of recesses 21d. In the embodiment the holder body 21 includes three recesses 21d. The support surface 21a supports the optical element 10. The support surface 21a is a surface that faces the reflection surface 13 of the optical element 10 and is connected to the pair of side surface units 22. The support surface 21a is an inclination surface inclined by about 45 degrees with respect to the incident direction of the light L, and is in contact with the reflection surface 13 of the optical element 10 over substantially an entire area of the inclination surface. The incident direction of the light L is a direction toward one side X1 in the first direction X. The recess 21d is disposed on the support surface 21a. The recess 21d is recessed on the side opposite to the optical element 10. The holder body 21 does not need to include the recess 21d.

The holder body 21 includes a back surface 21b and a lower surface 21c. The back surface 21b is connected to the support surface 21a at an end on the side opposite to the emission direction of the light L. The “emission direction of the light L” is one side Y1 in the second direction Y. The “end on the side opposite to the emission direction of the light L” is the end on the other side Y2 in the second direction Y. The lower surface 21c is connected to the support surface 21a and the back surface 21b.

The pair of side surface units 22 extend in an intersection direction intersecting the third direction Z from the holder body 21. For example, the intersection direction includes the first direction X and the second direction Y. The pair of side surface units 22 are disposed at both ends of the holder body 21 in the third direction Z. The pair of side surface units 22 has a shape symmetrical to each other in the third direction Z. The pair of opposing side surfaces 22a are disposed on the pair of side surface units 22. The pair of opposing side surfaces 22a is opposite to a pair of the preload units 40. A detailed structure of the preload unit 40 will be described later. The axial recess 22b is disposed on the opposing side surface 22a. The axial recess 22b is recessed toward an inside of the holder 20 on the first swing axis A1. The axial recess 22b accommodates at least a part of an axial protrusion 45 of the preload unit 40. The axial recess 22b includes at least a part of a recessed spherical surface.

One of the holder 20 and the first support 30 includes a restriction recess 22c. The restriction recess 22c restricts a protrusion 46 of the preload unit 40 from moving in the direction intersecting the first swing axis A1.

In the embodiment, the holder 20 includes the restriction recess 22c. Specifically, the restriction recess 22c is disposed in the opposing side surface 22a. The restriction recess 22c restricts the preload unit 40 from moving by at least a predetermined distance along the side surface unit 22. More specifically, the restriction recess 22c is recessed toward the inside of the holder 20 in the third direction Z. The restriction recess 22c includes an inner surface 22d. For example, the restriction recess 22c may be a recess in which both sides in the first direction X and both sides in the second direction Y are closed. For example, the restriction recess 22c may be a recess in which one side in the first direction X is opened or a recess in which one side in the second direction Y is opened.

The protrusion 46 of the preload unit 40 is disposed in the restriction recess 22c. The protrusion 46 of the preload unit 40 is separated from the inner surface 22d of the restriction recess 22c at a predetermined distance while the axial protrusion 45 is fitted in the axial recess 22b. On the other hand, when impact or the like is applied to the optical unit 1 and when the holder 20 is about to move in the first direction X and the second direction Y by at least a predetermined distance, the protrusion 46 of the preload unit 40 comes into contact with the inner surface 22d of the restriction recess 22c. Accordingly, the holder 20 can be prevented from coming off from the preload unit 40. In the embodiment, for example, four restriction recesses 22c are provided. The number of the restriction recesses 22c may be one, but preferably a plurality of restriction recesses 22c are provided.

The optical unit 1 includes the preload unit 40. The preload unit 40 connects the holder 20 and the first support 30. The preload unit 40 is elastically deformable. The preload unit 40 is disposed on at least one of the holder 20 and the first support 30. The preload unit 40 applies a preload to at least the other of the holder 20 and the first support 30 in an axial direction of the first swing axis A1. Accordingly, the holder 20 can be prevented from displacing in the axial direction of the first swing axis A1 with respect to the first support 30. Even when a manufacturing error is generated in dimensions of each member, rattling or the like can be prevented from being generated in the axial direction of the first swing axis A1. In other words, for example, the position of the holder 20 can be prevented from being displaced in the axial direction of the first swing axis A1. The axial direction of the first swing axis A1 is a direction along the third direction Z. In the present description, “applying preload” means previously applying a load.

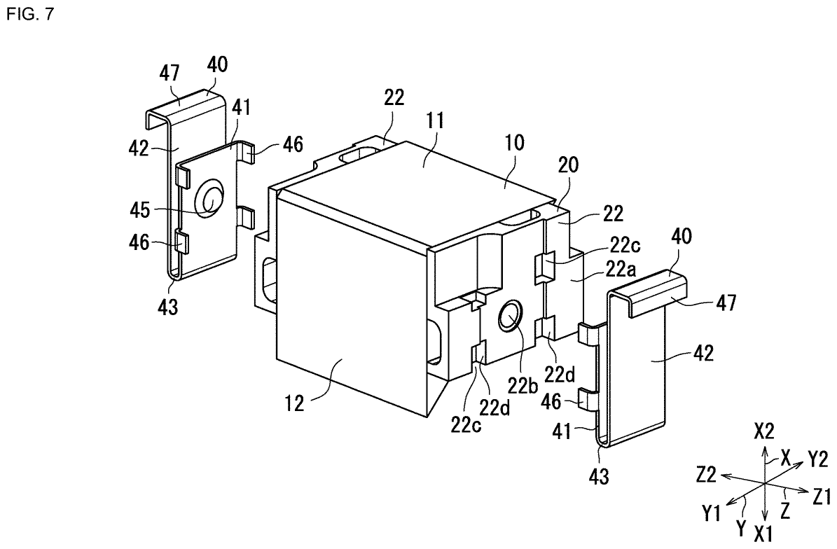

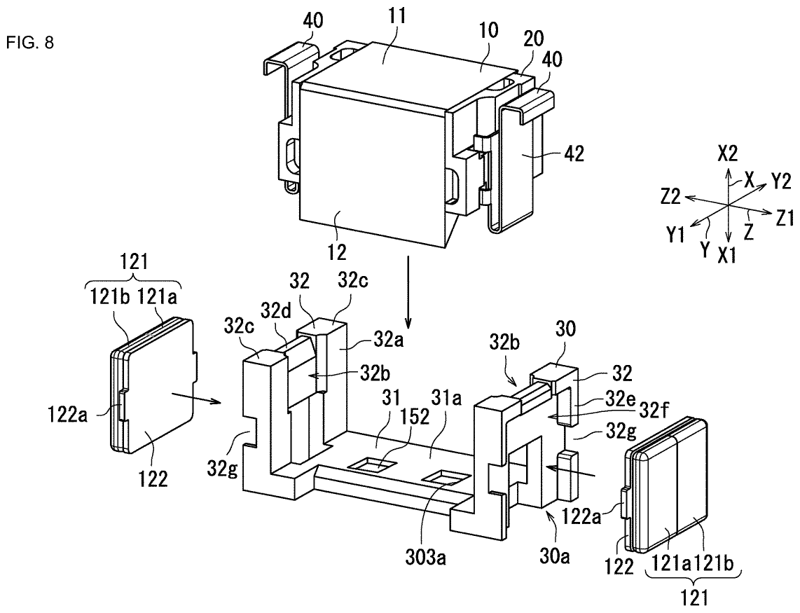

With reference to FIGS. 7 and 8, the detailed structure of the preload unit 40 will be described below. FIG. 7 is an exploded perspective view illustrating the optical element 10, the holder 20, and the preload unit 40 of the optical unit 1 of the embodiment. FIG. 8 is an exploded perspective view illustrating the optical element 10, the holder 20, the preload unit 40, the first support 30, and a second magnet 121 of the optical unit 1 of the embodiment. As illustrated in FIGS. 7 and 8, the preload unit 40 is disposed between the holder 20 and the first support 30. The preload unit 40 applies the preload to the holder 20 in the axial direction of the first swing axis A1.

Specifically, in the embodiment, each preload unit 40 is a single member. The preload unit 40 is formed by bending one plate member. In the embodiment, the preload unit 40 is a plate spring. The preload unit 40 is disposed on the first support 30.

The preload unit 40 includes a first surface 41 located on the side of the holder 20, a second surface 42 located on the side of the first support 30, and a curved unit 43 connecting the first surface 41 and the second surface 42. Accordingly, the preload unit 40 can be easily deformed in the axial direction of the first swing axis A1. As a result, elastic force is generated due to the bending of the curved unit 43, so that the preload can be easily applied to the holder 20 in the axial direction with a simple configuration.

Specifically, the first surface 41 is opposite to the holder 20 in the axial direction of the first swing axis A1. The first surface 41 is opposite to the side surface unit 22 of the holder 20. The first surface 41 extends along the first direction X and the second direction Y. The first surface 41 is disposed along the side surface unit 22. The second surface 42 is opposite to the first support 30 in the axial direction of the first swing axis A1. The second surface 42 is opposite to the side surface unit 32 of the first support 30. The second surface 42 extends along the first direction X and the second direction Y. The second surface 42 is disposed along the side surface unit 32.

The curved unit 43 is elastically deformable. Consequently, the first surface 41 and the second surface 42 can move in a direction where the first surface 41 and the second surface 42 approach or separate from each other. In the embodiment, the preload unit 40 is compressed and deformed in the axial direction of the first swing axis A1 such that the first surface 41 and the second surface 42 approach each other while the preload unit 40 is disposed between the holder 20 and the first support 30. Accordingly, the preload unit 40 applies the preload to the holder 20 by reaction force according to a deformation amount.

The preload unit 40 includes a protrusion protruding toward at least one of the holder 20 and the first support 30 or a recess recessed on the side opposite to at least one of the holder 20 and the first support 30. The protrusion or the recess of the preload unit 40 comes into contact with the protrusion or the recess of at least one of the holder 20 and the first support 30. In the embodiment, the preload unit 40 includes the axial protrusion 45. The axial protrusion 45 protrudes toward the holder 20. The axial protrusion 45 of the preload unit 40 comes into contact with the axial recess 22b of the holder 20.

In the embodiment, the axial protrusion 45 is disposed on the first surface 41. The axial protrusion 45 protrudes toward the holder 20 on the first swing axis A1. The axial protrusion 45 has at least a part of a spherical surface. A part of the axial protrusion 45 is accommodated in the axial recess 22b. Accordingly, the axial protrusion 45 and the axial recess 22b are in point contact with each other, so that the preload unit 40 can stably support the holder 20.

In the embodiment, a pair of preload units 40 is provided. That is, the optical unit 1 includes the pair of preload units 40. The pair of preload units 40 is disposed on both sides of the first swing axis A1 in the axial direction with respect to the holder 20. Accordingly, the holder 20 can be supported more stably as compared with the case where the preload unit 40 is disposed only on one side of the holder 20.

Specifically, the axial protrusions 45 of the pair of preload units 40 come into contact with the pair of axial recesses 22b of the holder 20. The holder 20 is supported by the preload unit 40 from both sides in the axial direction of the first swing axis A1 at two contact points in contact with the axial protrusion 45. Accordingly, the holder 20 can swing about the first swing axis A1 passing through the two contact points.

The preload unit 40 further includes the protrusion 46. The protrusion 46 is disposed on one of the first surface 41 and the second surface 42, and protrudes toward one of the holder 20 and the first support 30. In the embodiment, the protrusion 46 is disposed on the first surface 41 similarly to the axial protrusion 45. The protrusion 46 protrudes toward the holder 20 in the direction along the first swing axis A1. The protrusion 46 is provided corresponding to the restriction recess 22c. For example, four protrusions 46 are provided in each preload unit 40. A part of the protrusion 46 is accommodated in the restriction recess 22c. The protrusion 46 is disposed so as to surround the axial protrusion 45. In other words, the axial protrusion 45 is disposed inside a region containing the four protrusions 46. For example, the number of protrusions 46 may be 1 to 3, or at least 5. The protrusion 46 is formed by bending the end of the first surface 41.

The preload unit 40 includes an attachment unit 47. For example, the attachment unit 47 is disposed on the second surface 42. The attachment unit 47 is disposed at the upper end of the second surface 42. The attachment unit 47 is attached on the upper end of the side surface unit 32 of the first support 30. For example, the attachment unit 47 is attached to the side surface unit 32 by pinching the upper end of the side surface unit 32 in the first direction X. The preload unit 40 needs not to include the attachment unit 47, and for example, may be fixed to the first support 30 using an adhesive or the like.

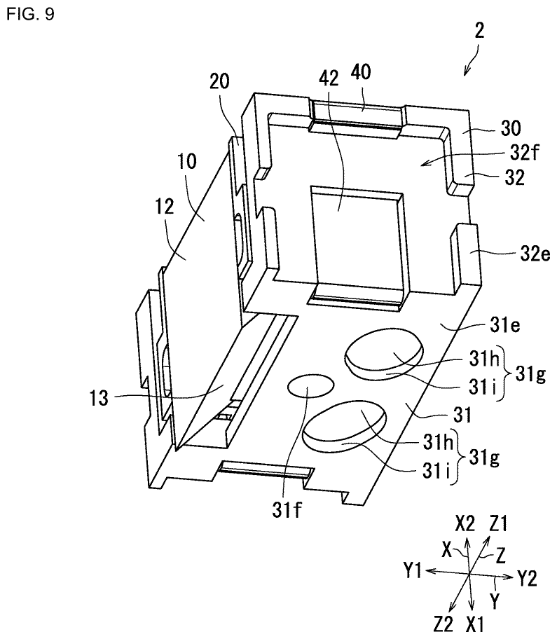

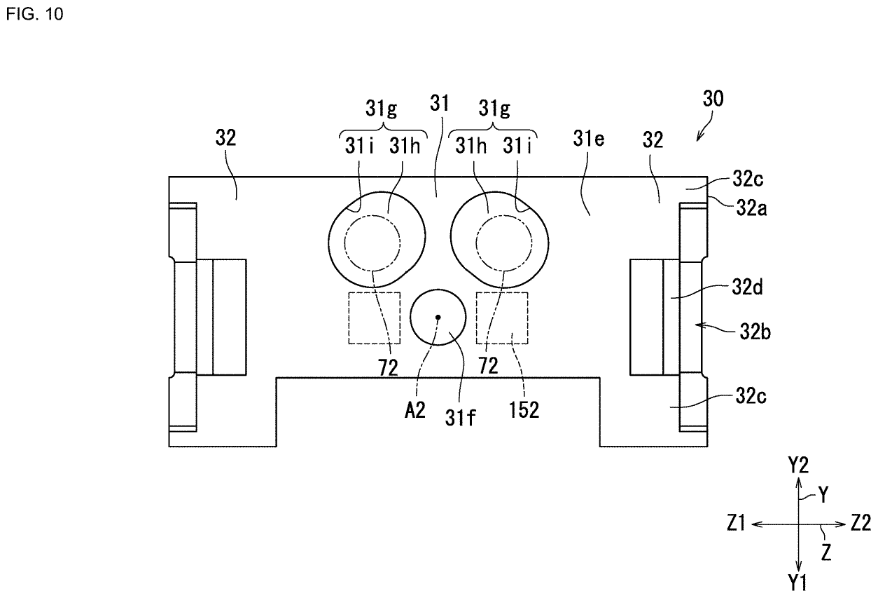

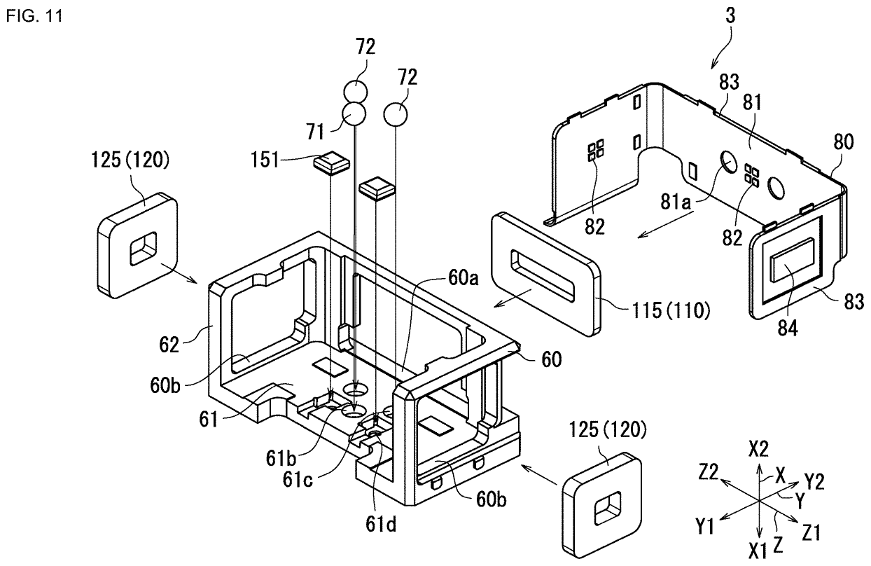

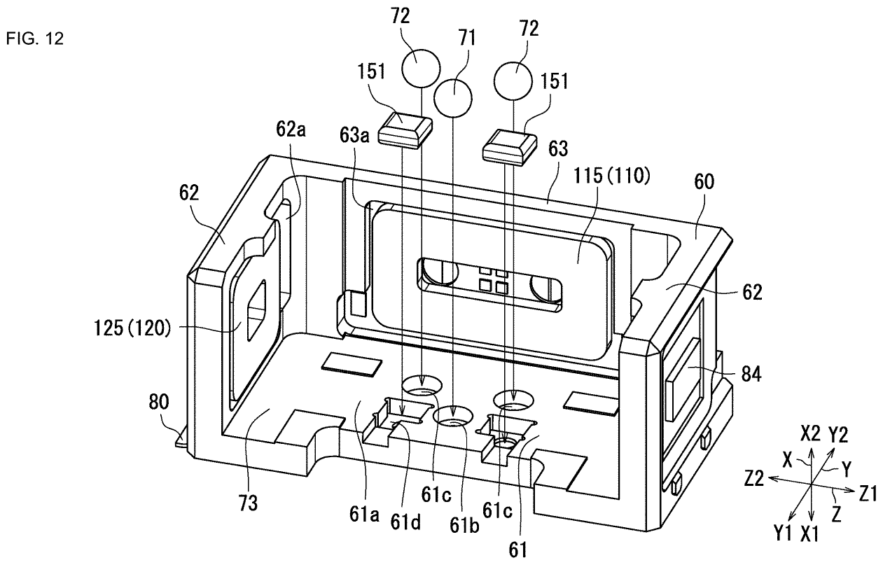

FIG. 9 is a perspective view illustrating the movable body 2 of the optical unit 1 of the embodiment. FIG. 10 is a view illustrating the first support 30 of the optical unit 1 of the embodiment as viewed from one side X1 in the first direction X. FIG. 11 is an exploded perspective view illustrating the support body 3 of the optical unit 1 of the embodiment. FIG. 12 is a perspective view illustrating a periphery of the second support 60 in the optical unit 1 of the embodiment.

As illustrated in FIGS. 9 to 12, one of the movable body 2 and the support body 3 includes a first protrusion 71 protruding toward the other of the movable body 2 and the support body 3. Specifically, one of the first support 30 and the second support 60 includes the first protrusion 71 protruding toward the other of the first support 30 and the second support 60. The other of the movable body 2 and the support body 3 comes into contact with the first protrusion 71. The first protrusion 71 is disposed on the second swing axis A2. Accordingly, the movable body 2 swings about the first protrusion 71.

Consequently, the length from the contact position between the movable body 2 and the support body 3 to the swing center can be reduced. Because the force required to swing the movable body 2 is a product of the length from the contact position to the swing center and frictional force, the force required to swing the movable body 2 can be reduced by disposing the first protrusion 71 on the second swing axis A2. That is, the force required to drive the optical unit 1 can be reduced. The material of the first protrusion 71 is not particularly limited, but for example, the first protrusion 71 is formed of ceramic, resin, or metal.

The first protrusion 71 is disposed on the second swing axis A2, so that the contact position between the movable body 2 and the support body 3 does not move with respect to the first protrusion 71. Accordingly, the frictional force between the other of the movable body 2 and the support body 3 and the first protrusion 71 can be reduced, for example, as compared with the case where the other of the movable body 2 and the support body 3 swings with respect to the first protrusion 71 when the movable body 2 swings. The optical axis L10 and the second swing axis A2 are disposed to overlap each other, so that the optical axis L10 can be prevented from deviating from the second swing axis A2 when the movable body 2 is swung.

In the embodiment, the support body 3 includes the first protrusion 71. Accordingly, the first protrusion 71 can be prevented from rotating when the movable body 2 swings. Consequently, the movable body 2 can be stably supported by the first protrusion 71. As a result, the swing of the movable body 2 is stabilized.

One of the movable body 2 and the support body 3 includes a plurality of second protrusions 72 protruding toward the other of the movable body 2 and the support body 3. Specifically, one of the first support 30 and the second support 60 includes the plurality of second protrusions 72 protruding toward the other of the first support 30 and the second support 60. The plurality of second protrusions 72 are disposed at positions separated from the second swing axis A2. The other of the movable body 2 and the support body 3 comes into contact with the plurality of second protrusions 72. The first protrusion 71 and the plurality of second protrusions 72 are disposed on the same plane intersecting the second swing axis A2. Accordingly, the movable body 2 can be supported by the first protrusion 71 and the plurality of second protrusions 72 disposed on the same plane. As a result, the movable body 2 can be stably supported. Examples of the same plane on which the first protrusion 71 and the plurality of second protrusions 72 are disposed include a plane including an opposing surface 61a and a plane including a lower surface 31e. The material of the second protrusion 72 is not particularly limited, but for example, the second protrusion 72 is formed of ceramic, resin, or metal.

The position of the second protrusion 72 is constant. In other words, the second protrusion 72 does not move with respect to one of the movable body 2 and the support body 3. In the embodiment, the second protrusion 72 does not move with respect to the support body 3. In other words, in the embodiment, the position of the second protrusion 72 with respect to the support body 3 is constant even when the movable body 2 swings. Accordingly, the movable body 2 can be supported more stably.

In the embodiment, the number of second protrusions 72 is two. Accordingly, the movable body 2 is supported by three protrusions (first protrusion 71 and second protrusions 72), so that the movable body 2 can be supported more stably as compared with the case where the movable body 2 is supported by at least four protrusions. In the embodiment, the movable body 2 is in point contact at three points, so that the movable body 2 can be supported more stably.

The other of the movable body 2 and the support body 3 includes a first recess 31f recessed in the direction opposite to the first protrusion 71. The first recess 31f comes into contact with the first protrusion 71. Accordingly, the center of the first protrusion 71 can be prevented from deviating from the center axis of the first recess 31f by receiving the first protrusion 71 at the first recess 31f having the recessed shape. As a result, the image blur due to deviation of the center of rotation can be prevented. The swing of the movable body 2 can be prevented from becoming unstable due to the deviation of the rotation center. As a result, for example, the current value required to swing can be prevented from fluctuating.

In the embodiment, the movable body 2 includes the first recess 31f, and the support body 3 includes the first protrusion 71. Accordingly, when the first protrusion 71 has the sphere, the movable body 2 can be assembled to the support body 3 while the sphere is disposed on the second support 60, so that the assembly work can be facilitated.

With reference to FIGS. 8 and 9, the structure around the first support 30 will be described in detail below. As illustrated in FIGS. 8 and 9, the first support 30 includes a support main body 31 and a pair of side surface units 32. The pair of side surface units 32 is disposed on both sides of the holder 20 in the axial direction of the first swing axis A1. The support main body 31 connects the pair of side surface units 32.

The support main body 31 includes an upper surface 31a. The upper surface 31a is opposite to the holder 20 in the first direction X. The upper surface 31a is separated from the bottom surface of the holder 20.

The pair of side surface units 32 is disposed at both ends of the support main body 31 in the third direction Z. The pair of side surface units 32 has the shapes symmetrical to each other in the third direction Z. The side surface unit 32 includes an inner side surface 32a. The inner side surface 32a is opposite to the holder 20 in the third direction Z.

One of the first support 30 and the holder 20 includes a groove 32b. The groove 32b is recessed on the side opposite to the other of the first support 30 and the holder 20 on the first swing axis A1. Accordingly, the holder 20 and the preload unit 40 can be easily attached to the first support 30 by moving the preload unit 40 along the groove 32b. In the embodiment, the first support 30 includes the groove 32b. The groove 32b is recessed on the side opposite to the holder 20 on the first swing axis A1. The groove 32b accommodates at least a part of the preload unit 40 and extends in the direction intersecting the first swing axis A1.

In the embodiment, the groove 32b is disposed on the inner side surface 32a. The groove 32b accommodates a part of the preload unit 40. The groove 32b extends in the first direction X.

Each side surface unit 32 includes a pair of columns 32c and a connection unit 32d. The pair of columns 32c is separated from each other in the second direction Y. The column 32c extends in the first direction X. The connection unit 32d connects upper portions of the columns 32c to each other. The length of the connection unit 32d in the third direction Z is shorter than the length of the column 32c in the third direction Z. The groove 32b is formed by the pair of columns 32c and the connection unit 32d.

The preload unit 40 can move along the groove 32b. In the embodiment, the preload unit 40 can move in the first direction X along the groove 32b. The attachment unit 47 of the preload unit 40 pinches the connection unit 32d in the third direction Z by moving the preload unit 40 along the groove 32b. Consequently, the preload unit 40 is fixed to the first support 30.

The side surface unit 32 includes an outer side surface 32e and an accommodation recess 32f. The outer side surface 32e faces the outside of the third direction Z. The accommodation recess 32f is disposed on the outer side surface 32e. The accommodation recess 32f accommodates at least apart of second magnets 121 of the second swing mechanism 120. The side surface unit 32 includes a pair of notches 32g. The notch 32g is disposed at the end in the second direction Y of the accommodation recess 32f. A projection 122a of a magnet support plate 122 is disposed in the notch 32g. The magnet support plate 122 supports the second magnet 121. The notch 32g supports the magnet support plate 122. The material of the magnet support plate 122 is not particularly limited, but for example, a magnetic material may be used. In this case, the magnet support plate 122 is also called a back yoke. Magnetic leakage can be prevented using the magnet support plate 122 made of a magnetic material.

The other of the movable body 2 and the support body 3 includes a second recess 31g. In the embodiment, the movable body 2 includes the second recess 31g. Specifically, the support main body 31 includes the lower surface 31e, the first recess 31f, and the second recess 31g. The lower surface 31e is opposite to the support body 3 in the first direction X. The first recess 31f and the second recess 31g are disposed in the lower surface 31e.

The first recess 31f is disposed on the second swing axis A2. The first recess 31f has a part of a recessed spherical surface. Accordingly, because the first protrusion 71 is received by the recessed spherical surface, for example, the first protrusion 71 is less likely to laterally deviate in the first recess 31f. As a result, the movable body 2 can be stably supported. On the other hand, for example, when the first recess 31f has a rectangular cross section, the first protrusion 71 tends to laterally deviate with respect to the first recess 31f. In the embodiment, for example, unlike the case where the first protrusion 71 and the first recess 31f have the rectangular cross section, the first protrusion 71 and the first recess 31f can be easily brought into point contact.

The second recess 31g is recessed in the direction opposite to the second protrusion 72. The second recess 31g is separated from the first recess 31f. That is, the second recess 31g is separated from the second swing axis A2. A plurality of second recesses 31g are provided. In the embodiment, two second recesses 31g are provided. The two second recesses 31g are disposed at equal distances to the second swing axis A2. The second recess 31g includes a sliding surface 31h and an inner side surface 31i.

The second recess 31g comes into contact with the second protrusion 72. Specifically, the sliding surface 31h of the second recess 31g comes into contact with the second protrusion 72. The sliding surface 31h is disposed substantially parallel to the lower surface 31e. That is, a depth of the second recess 31g is substantially constant.

As illustrated in FIG. 10, a contour of the second recess 31g is disposed outside the second protrusion 72 as viewed from the optical axis direction. Accordingly, the second protrusion 72 can be prevented from coming into contact with the inner side surface 31i of the second recess 31g. As a result, friction between the second protrusion 72 and the second recess 31g can be prevented. Specifically, the inner side surface 31i surrounds the sliding surface 31h. The inner side surface 31i is separated from the second protrusion 72. That is, as viewed from the optical axis direction, the contour of the second recess 31g is separated with respect to the second protrusion 72. The inner side surface 31i is disposed at a position where the second protrusion 72 does not come into contact when the first support 30 is swung by the second swing mechanism 120 about the second swing axis A2.

As illustrated in FIGS. 3 and 5A, the second protrusion 72 is disposed on the other side Y2 in the second direction Y relative to the first recess 31f. Accordingly, the second protrusion 72 can be prevented from coming into contact with the reflection surface 13 of the optical element 10. As a result, a space where the optical element 10 is disposed can be easily secured. The larger optical element 10 can also be mounted. Specifically, a part of the reflection surface 13 protrudes on one side X1 in the first direction X and one side Y1 in the second direction Y with respect to the lower surface 31e. Accordingly, the optical element 10 can be prevented from coming into contact with a part of the first support 30 where the second protrusion 72 is disposed. As a result, the space where the optical element 10 is disposed can be easily secured.

As illustrated in FIGS. 11 and 12, the support body 3 includes the second support 60, the first protrusion 71, and the second protrusion 72. The support body 3 preferably includes the opposing surface 61a.

Specifically, the second support 60 supports the first support 30 while being swingable about the second swing axis A2 intersecting the first swing axis A1. The second support 60 supports the first support 30 in the first direction X. That is, the second support 60 supports the movable body 2 in the first direction X. Accordingly, a change in the position of the optical element 10 can be prevented in the first direction X, so that a change in the position of the reflected light (the light L emitted from the optical element 10) can be prevented in the first direction X.

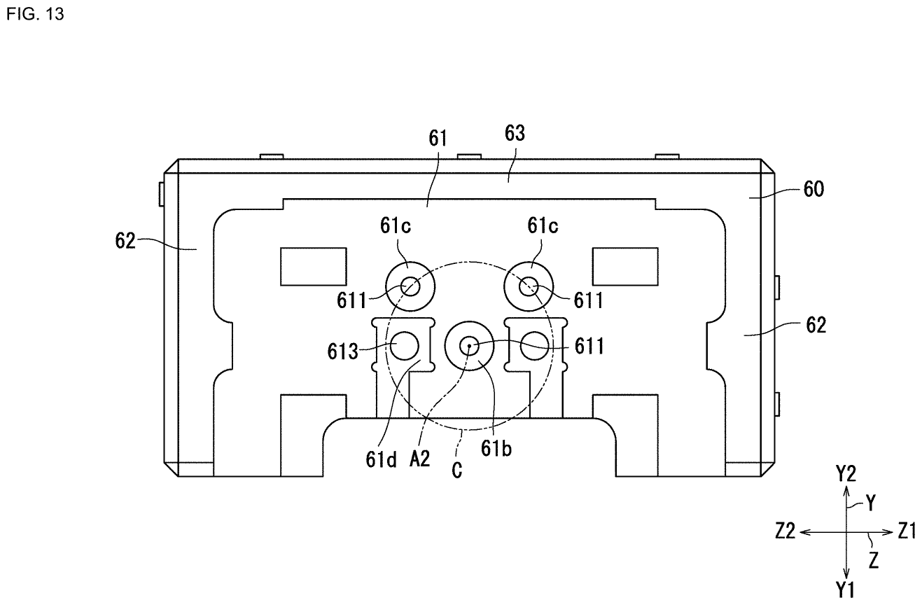

FIG. 13 is a view illustrating the second support 60 of the optical unit 1 of the embodiment as viewed from the other side X2 in the first direction X. As illustrated in FIGS. 11 and 13, the second support 60 includes a support main body 61, a pair of side surface units 62, and a back surface unit 63. The support main body 61 includes the opposing surface 61a, a first accommodation recess 61b, and at least two second accommodation recesses 61c. In the embodiment, the support main body 61 includes one first accommodation recess 61b and two second accommodation recesses 61c. In the embodiment, an example in which the second support 60 includes the first accommodation recess 61b and the second accommodation recess 61c will be described. However, one of the movable body 2 and the support body 3 may include the first accommodation recess and the second accommodation recess that are recessed in the direction opposite to the other of the movable body 2 and the support body 3. For example, one of the movable body 2 and the support body 3 may include the first accommodation recess, and the other of the movable body 2 and the support body 3 may include the second accommodation recess.

The opposing surface 61a is opposite to the lower surface 31e of the first support 30 in the first direction X. The first accommodation recess 61b and the second accommodation recess 61c are disposed on the opposing surface 61a. The first accommodation recess 61b and the second accommodation recess 61c are recessed in the direction opposite to the movable body 2 in the first direction X. That is, the first accommodation recess 61b and the second accommodation recess 61c are recessed to one side X1 in the first direction X. The first accommodation recess 61b is opposite to the first recess 31f of the first support 30 in the first direction X. The first accommodation recess 61b is disposed on the same circumference C (see FIG. 13) about the second swing axis A2. The first accommodation recess 61b accommodates a part of the first protrusion 71. Accordingly, the first protrusion 71 is disposed on the second swing axis A2.

The second accommodation recess 61c is separated from the first accommodation recess 61b. Accordingly, the second accommodation recess 61c is separated from the second swing axis A2. In the embodiment, the second accommodation recess 61c is separated at a distance from the first accommodation recess 61b. The second accommodation recess 61c accommodates a part of the second protrusion 72. Accordingly, the plurality of second protrusions 72 are disposed on the same circumference C about the second swing axis A2. Accordingly, the movable body 2 can be supported at a position with an equal distance from the first protrusion 71. As a result, the movable body 2 can be supported more stably. The axial direction of the second swing axis A2 is the direction along the first direction X.

The two second accommodation recesses 61c are disposed at positions farther to the optical element 10 relative to the first accommodation recess 61b while arranged in the third direction Z.

The first accommodation recess 61b holds a part of the first protrusion 71. In the embodiment, the lower half of the first protrusion 71 is disposed in the first accommodation recess 61b. The first protrusion 71 includes at least a part of a spherical surface. Accordingly, the first protrusion 71 comes into point contact with the other of the movable body 2 and the support body 3, so that the frictional force between the first protrusion 71 and the other of the movable body 2 and the support body 3 can be reduced. In the embodiment, the first protrusion 71 comes into point contact with the movable body 2, so that the frictional force between the first protrusion 71 and the movable body 2 can be reduced.

In the embodiment, the first protrusion 71 is a sphere. Accordingly, the friction between the first protrusion 71 and the first recess 31f becomes rolling friction. As a result, an increase in the frictional force between the first protrusion 71 and the first recess 31f can be prevented. Specifically, the first protrusion 71 can rotate in the first accommodation recess 61b. Accordingly, the friction between the first protrusion 71 and the first recess 31f becomes the rolling friction. The first protrusion 71 may be fixed to the first recess 31f by using, for example, an adhesive.

The second accommodation recess 61c holds a part of the second protrusion 72. In the embodiment, the lower half of the second protrusion 72 is disposed in the second accommodation recess 61c. The second protrusion 72 includes at least a part of a spherical surface. Accordingly, the second protrusion 72 comes into point contact with the other of the movable body 2 and the support body 3, so that the frictional force between the second protrusion 72 and the other of the movable body 2 and the support body 3 can be reduced. In the embodiment, the second protrusion 72 is in point contact with the movable body 2, so that the frictional force between the second protrusion 72 and the movable body 2 can be reduced.

In the embodiment, the second protrusion 72 is a sphere. Accordingly, the friction between the second protrusion 72 and the other of the movable body 2 and the support body 3 becomes the rolling friction, so that the frictional force can be prevented. In the embodiment, the friction between the second protrusion 72 and the movable body 2 becomes the rolling friction. Specifically, the second protrusion 72 can rotate in the second accommodation recess 61c. Accordingly, the friction between the second protrusion 72 and the second recess 31g of the first support 30 becomes the rolling friction. The second protrusion 72 may be fixed to the second recess 31g by using, for example, an adhesive.

As illustrated in FIGS. 5C and 13, the first accommodation recess 61b may include a center recess 611. The center recess 611 is disposed on the same circumference with the first accommodation recess 61b. The first protrusion 71 comes into contact with the edge of the center recess 611. A diameter of the center recess 611 is smaller than a diameter of the first protrusion 71. Accordingly, for example, even when a gap is generated between the outer peripheral surface of the first protrusion 71 and the inner peripheral surface of the first accommodation recess 61b, the first protrusion 71 can be positioned by the center recess 611. That is, the center of the first protrusion 71 can be disposed on the center axis of the center recess 611. As a result, the center of the first protrusion 71 can be easily disposed on the center axis of the first accommodation recess 61b.

As illustrated in FIGS. 5D and 13, the second accommodation recess 61c may include the center recess 611. The center recess 611 is disposed on the same circumference with the second accommodation recess 61c. The second protrusion 72 comes into contact with the edge of the center recess 611. The diameter of the center recess 611 is smaller than the diameter of the second protrusion 72. Accordingly, for example, even when the gap is generated between the outer peripheral surface of the second protrusion 72 and the inner peripheral surface of the second accommodation recess 61c, the second protrusion 72 can be positioned by the center recess 611. That is, the center of the second protrusion 72 can be disposed on the center axis of the center recess 611. As a result, the center of the second protrusion 72 can be easily disposed on the center axis of the second accommodation recess 61c.

The materials of the first protrusion 71 and the second protrusion 72 are ceramic. Accordingly, it is possible to suppress the first protrusion 71 and the second protrusion 72 can be prevented from becoming worn. The materials of the first protrusion 71 and the second protrusion 72 may be metal. Also in this case, the first protrusion 71 and the second protrusion 72 can be prevented from becoming worn. The entire first protrusion 71 and entire second protrusion 72 may be formed of metal, or for example, only the surfaces of the first protrusion 71 and the second protrusion 72 may be formed of metal by plating. The first protrusion 71 and the second protrusion 72 may be formed of resin.

The first protrusion 71 is disposed on one side X1 in the first direction X with respect to the reflection surface 13 (see FIG. 5A) of the optical element 10. Accordingly, the first protrusion 71 can be disposed without blocking the light path.

As illustrated in FIGS. 5C, 8, and 11, the optical unit 1 includes the magnet 151 disposed on one of the movable body 2 and the support body 3 and the magnetic member 152 disposed on the other of the movable body 2 and the support body 3. The magnetic member 152 is a plate-like member made of a magnetic material. The magnet 151 and the magnetic member 152 overlap each other. Specifically, the magnet 151 and the magnetic member 152 overlap each other as viewed from the direction (first direction X) in which the support body 3 supports the movable body 2. Accordingly, in the direction in which the support body 3 supports the movable body 2, force (hereinafter, also referred to as attractive force) attracting the magnet 151 and the magnetic member 152 to each other can be generated between the magnet 151 and the magnetic member 152.

As described above, because the magnet 151 and the magnetic member 152 overlap each other, the force acts between the movable body 2 and the support body 3 in the direction approaching each other. In other words, the attractive force acts on the movable body 2 and the support body 3. Accordingly, when the first swing mechanism 110 and the second swing mechanism 120 are not driven, the movable body 2 is held at the reference position by the attractive force between the magnet 151 and the magnetic member 152. As illustrated in FIG. 5B, the reference position is a position where the side surface unit 32 of the first support 30 and the side surface unit 62 of the second support 60 become parallel to each other. In addition, the movable body 2 can be prevented from moving to the other side X2 in the first direction X due to the attractive force generated between the magnet 151 and the magnetic member 152.

As illustrated in FIGS. 5C, 8, and 11, at least one of the movable body 2 and the support body 3 includes a covering unit 301 disposed between the magnet 151 and the magnetic member 152. The covering unit 301 covers at least a part of the contour of one of the magnet 151 and the magnetic member 152. Accordingly, the covering unit 301 can prevents one of the magnet 151 and the magnetic member 152 from peeling or positional displacement. For example, the covering unit 301 may cover the entire contour of one of the magnet 151 and the magnetic member 152.

The material of the covering unit 301 is not particularly limited, and for example, resin or metal can be used. In the embodiment, for example, the covering unit 301 is formed of resin that is a non-magnetic material.

At least a part of one of the magnet 151 and the magnetic member 152 is disposed inside at least one of the movable body 2 and the support body 3. In the embodiment, one of the magnet 151 and the magnetic member 152 is entirely disposed inside at least one of the movable body 2 and the support body 3. Accordingly, the increase in size of at least one of the movable body 2 and the support body 3 can be prevented, for example, unlike the case where one of the magnet 151 and the magnetic member 152 is disposed outside at least one of the movable body 2 and the support body 3.

In the embodiment, the magnet 151 is disposed in the support body 3. The magnetic member 152 is disposed in the movable body 2. In the embodiment, the movable body 2 includes the covering unit 301 disposed between the magnet 151 and the magnetic member 152. The covering unit 301 covers the entire surface (hereinafter, sometimes referred to as a lower surface 152a) of the magnetic member 152 on the side of the magnet 151. In the embodiment, the entire magnetic member 152 is disposed inside the movable body 2.

In addition, at least one of the movable body 2 and the support body 3 includes a first member including an accommodation unit 303a in which one of the magnet 151 and the magnetic member 152 is disposed, and the covering unit 301. The first member and the covering unit 301 are a single member. Accordingly, for example, the number of components can be reduced as compared with the case where the first member and the covering unit 301 are formed as separate members. As described later, the first member and the covering unit 301 may be different from each other. In the embodiment, the movable body 2 includes the support main body 31 including the accommodation unit 303a in which one of the magnet 151 and the magnetic member 152 is disposed. The support main body 31 is an example of the “first member” of the present disclosure. In addition, in the embodiment, the movable body 2 includes the support main body 31 including the accommodation unit 303a in which the magnetic member 152 is disposed, and the covering unit 301.

In addition, the first member includes an opposite surface facing the side opposite to at least the other of the movable body 2 and the support body 3. The accommodation unit 303a is recessed from the opposite surface toward at least the other of the movable body 2 and the support body 3. Accordingly, the first member and the covering unit 301 can be easily formed of a single member. In the embodiment, the support main body 31 includes the upper surface 31a facing the side opposite to the support body 3. That is, in the embodiment, the support main body 31 includes the upper surface 31a facing the other side X2 in the first direction X at the position opposite to the lower surface 31e in the first direction X. The lower surface 31e is opposite to the other side X2 of the first direction X with respect to the opposing surface 61a of the support body 3. The accommodation unit 303a is recessed from the upper surface 31a toward the support body 3. The upper surface 31a is an example of the “opposite surface” of the present disclosure.

The magnetic member 152 is fitted in the accommodation unit 303a. Accordingly, the magnetic member 152 is fixed to the accommodation unit 303a. For example, the magnetic member 152 is fixed to the accommodation unit 303a by an adhesive or press-fitting.

A plurality of magnets 151 and a plurality of magnetic members 152 may be provided. In other words, the optical unit 1 may include the plurality of magnets 151 and the plurality of magnetic members 152. In the embodiment, the optical unit 1 includes two magnets 151 and two magnetic members 152.

In the embodiment, each of the magnets 151 and the magnetic members 152 are disposed symmetrically about the second swing axis A2 in the third direction Z intersecting the first direction X and the second direction Y. Accordingly, because the attractive force acts symmetrically about the second swing axis A2, the swing of the movable body 2 is stabilized.

The other of the magnet 151 and the magnetic member 152 is disposed inside the other of the movable body 2 and the support body 3. In the embodiment, the magnet 151 is disposed inside the support body 3. Specifically, the support body 3 includes a third accommodation recess 61d. The support body 3 includes a plurality of third accommodation recesses 61d. In the embodiment, the support body 3 includes two third accommodation recesses 61d.

The third accommodation recess 61d is disposed on the opposing surface 61a of the support main body 61. The third accommodation recess 61d is recessed in the direction opposite to the movable body 2 in the first direction X. That is, the third accommodation recess 61d is recessed to one side X1 in the first direction X. The third accommodation recess 61d is opposite to the magnetic member 152 in the first direction X. That is, the third accommodation recess 61d and the magnetic member 152 overlap each other as viewed from the first direction X.

The magnet 151 is fitted in the third accommodation recess 61d. Accordingly, the magnet 151 is fixed to the third accommodation recess 61d. For example, the magnet 151 is fixed to the third accommodation recess 61d by an adhesive or press-fitting.

In the embodiment, the magnet 151 is fixed to the third accommodation recess 61d by an adhesive. Specifically, as illustrated in FIGS. 5C and 13, the third accommodation recess 61d includes an adhesive recess 613. The adhesive recess 613 is disposed in the center of the third accommodation recess 61d. When the magnet 151 is fixed to the third accommodation recess 61d, the magnet 151 is disposed inside the third accommodation recess 61d after an adhesive (not illustrated) is disposed in the third accommodation recess 61d. As a result, the magnet 151 is fixed to the third accommodation recess 61d by the adhesive (not illustrated).

In the embodiment, the magnet 151 and the second magnet 121 (to be described later) of the second swing mechanism 120 are different from each other. Accordingly, unlike the case where the magnet 151 constitutes the second swing mechanism 120, the magnet 151 can be a dedicated magnet that generates the attractive force with the magnetic member 152, so that the magnet 151 can be disposed at the position close to the magnetic member 152. Consequently, even when the magnet 151 and the magnetic member 152 are made small, the attractive force can be sufficiently generated between the magnet 151 and the magnetic member 152.

As illustrated in FIGS. 12 and 13, in the second support 60, the pair of side surface units 62 are disposed at both ends in the third direction Z of the support main body 61. The pair of side surface units 62 have shapes symmetrical to each other in the third direction Z. The side surface unit 62 includes an accommodation hole 62a in which a second coil 125 of the second swing mechanism 120 is disposed. The accommodation hole 62a penetrates the side surface unit 62 in the thickness direction. That is, the accommodation hole 62a penetrates the side surface unit 62 in the third direction Z.

The back surface unit 63 is disposed at the end on the other side Y2 in the second direction Y of the support main body 61. The back surface unit 63 includes an accommodation hole 63a in which a first coil 115 of the first swing mechanism 110 is disposed. The accommodation hole 63a penetrates the back surface unit 63 in the thickness direction. That is, the accommodation hole 63a penetrates the back surface unit 63 in the second direction Y.

A flexible printed circuit (FPC) 80 is disposed so as to cover the outside of the pair of side surface units 62 and the outside of the back surface unit 63. For example, the FPC 80 includes a semiconductor element, a connection terminal, and a wiring. The FPC 80 supplies the power to the first coil 115 of the first swing mechanism 110 and the second coil 125 of the second swing mechanism 120 at predetermined timing.

Specifically, as illustrated in FIG. 11, the FPC 80 includes a substrate 81, a connection terminal 82, a reinforcing plate 83, and a magnetic member 84. For example, the substrate 81 is made of a polyimide substrate. The substrate 81 has flexibility. The substrate 81 includes a plurality of pin insertion holes 81a. The pin insertion holes 81a are opposite to the first coil 115. A coil pin (not illustrated) of the first coil 115 is disposed in each pin insertion hole 81a.

The connection terminal 82 is disposed on the substrate 81. The connection terminal 82 is opposite to the first swing mechanism 110 and the second swing mechanism 120. The connection terminal 82 is electrically connected to a terminal of a Hall element (not illustrated). For example, four connection terminals 82 are disposed for one Hall element. Three reinforcing plates 83 are disposed on the substrate 81. The reinforcing plates 83 are opposite to the first swing mechanism 110 and the second swing mechanism 120. The reinforcing plate 83 prevents the substrate 81 from bending.

Three magnetic members 84 are disposed on the substrate 81. Two of the magnetic members 84 are opposite to the second magnet 121 of the second swing mechanism 120. The attractive force is generated between the second magnet 121 and the magnetic member 84 while the second coil 125 is not energized. Thus, the movable body 2 is disposed at the reference position in a rotation direction about the second swing axis A2. The remaining one of the magnetic members 84 is opposite to a first magnet 111 of the first swing mechanism 110. The attractive force is generated between the first magnet 111 and the magnetic member 84 while the first coil 115 is not energized. Thus, the movable body 2 is disposed at the reference position in a rotation direction about the first swing axis A1. The generation of the attractive force between the first magnet 111 and the magnetic member 84 can prevent the holder 20 from coming off to one side Y1 of the second direction Y.

As illustrated in FIGS. 5A and 5B, the optical unit 1 further includes the first swing mechanism 110. The first swing mechanism 110 swings the holder 20 with respect to the first support 30 about the first swing axis A1. Accordingly, the optical element 10 can be easily swung about each of the two swing axes (the first swing axis A1 and the second swing axis A2). The first swing mechanism 110 includes the first magnet 111 and the first coil 115. The first coil 115 is opposite to the first magnet 111 in the second direction Y.

The first magnet 111 is disposed in one of the holder 20 and the second support 60. On the other hand, the first coil 115 is disposed in the other of the holder 20 and the second support 60. Accordingly, the force acts on the first magnet 111 due to a magnetic field generated when the current flows through the first coil 115. The holder 20 swings with respect to the first support 30. Thus, the holder 20 can be swung with a simple configuration using the first magnet 111 and the first coil 115. In the embodiment, the first magnet 111 is disposed in the holder 20. The first coil 115 is disposed on the second support 60. Because the first coil 115 is disposed on the second support 60, the first coil 115 does not swing with respect to the second support 60. Accordingly, wiring can be easily performed on the first coil 115, for example, as compared with the case where the first coil 115 is disposed on the first support 30.

Specifically, the first magnet 111 is disposed in the back surface 21b of the holder 20. That is, the first magnet 111 is disposed at an end 20a on the other side Y2 in the second direction Y of the holder 20. The first magnet 111 includes an n-pole unit 111a including an n-pole and an s-pole unit 111b including an s-pole. The first magnet 111 is polarized in the first direction X.

The first coil 115 is disposed in the accommodation hole 63a of the back surface unit 63 of the second support 60. That is, the first coil 115 is disposed at an end 60a on the other side Y2 in the second direction Y of the second support 60. Accordingly, the first coil 115 and the first magnet 111 can be prevented from being disposed on the light path. Thus, the light path can be prevented from being blocked by the first coil 115 and the first magnet 111.

When the first coil 115 is energized, the magnetic field is generated around the first coil 115. Then, the force caused by the magnetic field acts on the first magnet 111. As a result, the holder 20 and the optical element 10 swing about the first swing axis A1 with respect to the first support 30 and the second support 60.

The second swing mechanism 120 swings the movable body 2 about the second swing axis A2. Specifically, the second swing mechanism 120 swings the first support 30 about the second swing axis A2 with respect to the second support 60. The second swing mechanism 120 includes the second magnet 121 and the second coil 125 opposite to the second magnet 121. The second magnet 121 is an example of the “swing magnet” of the present disclosure. The second coil 125 is an example of the “swing coil” of the present disclosure. The second magnet 121 is disposed on the movable body 2 or the support body 3. The second coil 125 is disposed on the support body 3 or the movable body 2. In the embodiment, the second magnet 121 is disposed on one of the first support 30 and the second support 60. On the other hand, the second coil 125 is disposed on the other of the first support 30 and the second support 60. Accordingly, the first support 30 swings with respect to the second support 60 by the magnetic field generated when the current flows through the second coil 125. Thus, the first support 30 can be swung with a simple configuration using the second magnet 121 and the second coil 125. In the embodiment, the second magnet 121 is disposed on the first support 30. The second coil 125 is disposed on the second support 60. When the second coil 125 is disposed on the second support 60, the second coil 125 does not swing with respect to the second support 60. Accordingly, the wiring can be easily performed on the second coil 125, for example, as compared with the case where the second coil 125 is disposed on the first support 30.

Specifically, the second magnet 121 is disposed in the accommodation recess 32f (see FIG. 8) of the side surface unit 32 of the first support 30. That is, the second magnet 121 is disposed at an end 30a in the direction intersecting the first direction X of the first support 30. In the embodiment, the second magnet 121 is disposed at the end 30a of the third direction Z. The second magnet 121 includes an n-pole unit 121a including the n-pole and an s-pole unit 121b including the s-pole. The second magnet 121 is polarized in the second direction Y intersecting the first direction X. Accordingly, the movable body 2 can be swung about the second swing axis A2 along the incident direction of light.

The second coil 125 is opposite to the second magnet 121 in the third direction Z. The second coil 125 is disposed in the accommodation hole 62a (see FIG. 12) of the side surface unit 62 of the second support 60. That is, the second coil 125 is disposed at an end 60b of the second support 60 in the third direction Z.

When the second coil 125 is energized, the magnetic field is generated around the second coil 125. Then, the force caused by the magnetic field acts on the second magnet 121. As a result, the first support 30, the holder 20, and the optical element 10 swing about the second swing axis A2 with respect to the second support 60.

When the optical unit 1 is used for the smartphone 200 as illustrated in FIG. 1, a Hall element (not illustrated) in the smartphone 200 detects the attitude of the smartphone 200. Then, the first swing mechanism 110 and the second swing mechanism 120 are controlled in response to the attitude of the smartphone 200. Preferably, the optical unit 1 can detect the attitude of the holder 20 with respect to the second support 60. In this case, the attitude of the holder 20 can be controlled with high accuracy with respect to the second support 60. For example, a gyro sensor may be used as a sensor that detects the attitude of the smartphone 200.

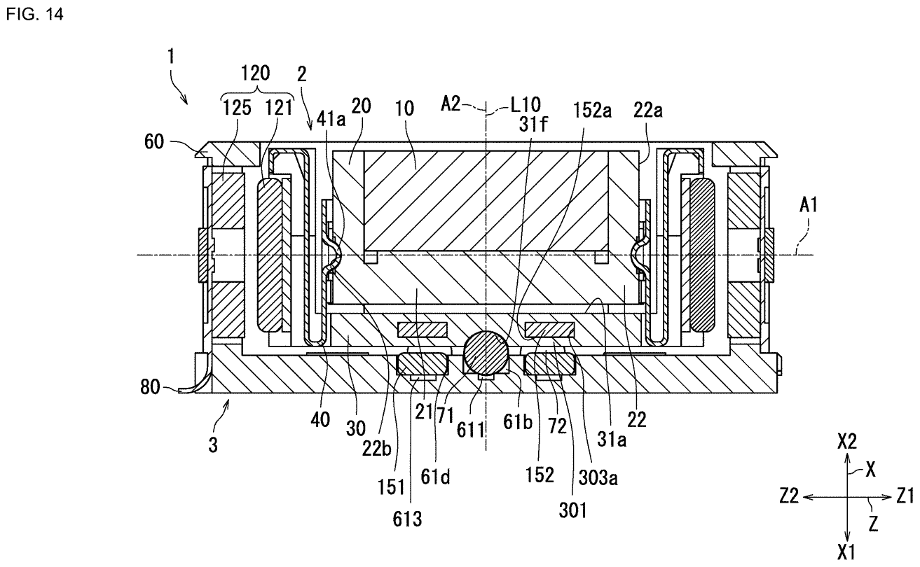

With reference to FIGS. 14 to 18, first to fourth modifications of the embodiment will be described below. Hereinafter, differences from the embodiment illustrated in FIGS. 1 to 13 will be mainly described.

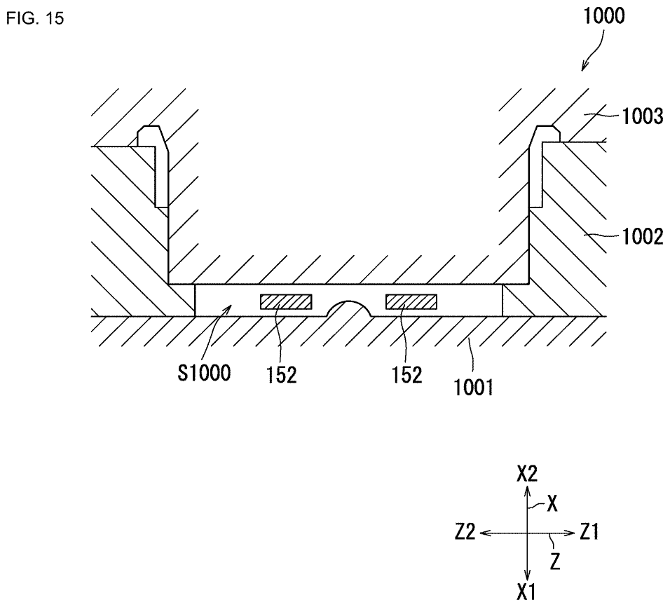

With reference to FIGS. 14 and 15, the first modification of the embodiment of the present disclosure will be described. FIG. 14 is a sectional view illustrating the structure of the optical unit 1 according to the first modification of the embodiment. In the first modification, unlike the embodiment illustrated in FIGS. 1 to 13, an example in which the first support 30 is molded using the magnetic member 152 as an insert component will be described.

As illustrated in FIG. 14, substantially the entire one of the magnet 151 and the magnetic member 152 is covered with at least one of the movable body 2 and the support body 3. In other words, substantially the entire area of one surface of the magnet 151 and the magnetic member 152 is covered with at least one of the movable body 2 and the support body 3. At least one of the movable body 2 and the support body 3 is formed by insert-molding one of the magnet 151 and the magnetic member 152 as the insert component. Accordingly, the peeling or positional displacement of the magnet 151 and the magnetic member 152 can be further prevented.

In the first modification, substantially the entire magnetic member 152 is covered with the first support 30. In other words, substantially the entire surface of the magnetic member 152 is covered with the first support 30. At least one of the movable body 2 and the support body 3 is formed by insert-molding the magnetic member 152 as the insert component. In the first modification, the first support 30 is formed by insert-molding the magnetic member 152 as the insert component. That is, the magnetic member 152 is disposed in the accommodation unit 303a of the first component (in this case, the first support 30). Accordingly, unlike the case where the magnet 151 is insert-molded as the insert component, demagnetization of the magnet 151 can be prevented due to heat at the time of insertion.

With reference to FIG. 15, the insert molding will be briefly described below. FIG. 15 is a schematic sectional view illustrating a method for manufacturing the first support 30 in the optical unit 1 of the first modification of the embodiment.

As illustrated in FIG. 15, the method for manufacturing the optical unit 1 includes a step of disposing the magnet 151 or the magnetic member 152 in a mold 1000, a step of injecting resin into the mold 1000 to mold at least one of the movable body 2 and the support body 3, and a step of supporting the movable body 2 by the support body 3. Through the step of molding at least one of the movable body 2 and the support body 3, at least one of the movable body 2 and the support body 3 includes the covering unit 301 that covers at least a part of the contours (edges) of the magnet 151 and the magnetic member 152.

The first modification includes a step of disposing the magnetic member 152 in the mold 1000, a step of injecting resin into the mold 1000 to mold the support body 3, and a step of supporting the movable body 2 by the support body 3. In the first modification, the step of molding the support body 3 includes a step of molding the first support 30.

Specifically, the mold 1000 includes a first mold 1001 that is a lower mold, a second mold 1002 disposed on the first mold 1001, and a third mold 1003 disposed on the second mold 1002.

In the case of molding the first support 30, first, the magnetic member 152 is disposed at a predetermined position on the first mold 1001. The first mold 1001 includes a protrusion or the like that supports the magnetic member 152, but is omitted in FIG. 15. The second mold 1002 is disposed on the first mold 1001. Thereafter, the third mold 1003 is disposed on the second mold 1002. As a result, as illustrated in FIG. 15, a space S1000 having substantially the same shape as the first support 30 is formed by the mold 1000. The magnetic member 152 is disposed in the space S1000.

Subsequently, by injecting the resin into the space S1000, the insert molding is performed using the magnetic member 152 as the insert component. As a result, the first support 30 in which the magnetic member 152 is integrated is manufactured.

Thereafter, the movable body 2 is assembled by attaching the holder 20, the preload unit 40, the second magnet 121, and the like to the first support 30. The covering unit 301 is disposed between the magnet 151 and the magnetic member 152 by disposing the movable body 2 in the support body 3. In other words, in the step of supporting the movable body 2 by the support body 3, the covering unit 301 is disposed between the magnet 151 and the magnetic member 152.

Other structures and effects of the first modification are similar to those of the embodiment illustrated in FIGS. 1 to 13.

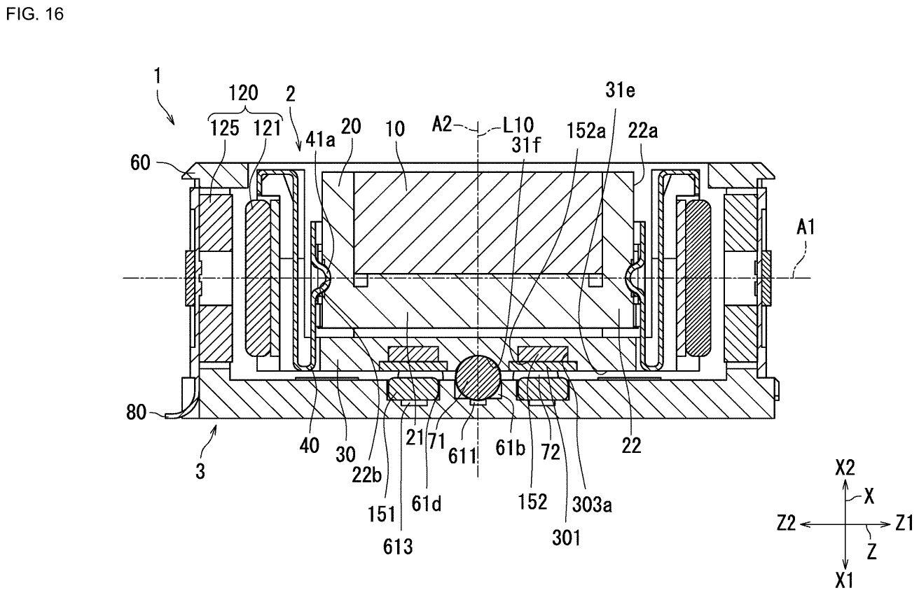

With reference to FIG. 16, the second modification of the embodiment of the present disclosure will be described. FIG. 16 is a sectional view illustrating the structure of the optical unit 1 according to the second modification of the embodiment. In the second modification, unlike the embodiment illustrated in FIGS. 1 to 13, an example in which the accommodation unit 303a is disposed on the surface facing at least the other side of the movable body 2 and the support body 3 will be described.

As illustrated in FIG. 16, the first member includes the opposing surface facing at least the other side of the movable body 2 and the support body 3. The accommodation unit 303a is recessed from the opposing surface toward the side opposite to at least the other of the movable body 2 and the support body 3. In the second modification, the first support 30 that is the first member includes the lower surface 31e facing the side of the support body 3. The accommodation unit 303a is recessed from the lower surface 31e toward the side opposite to the support body 3 (the other side X2 in the first direction X).

In the second modification, the first member and the covering unit 301 are different from each other. Accordingly, the material of the covering unit 301 can be made different from that of the first member, or the thickness of the covering unit 301 can be changed. That is, a degree of freedom in designing the first member and the covering unit 301 can be improved. In the second modification, the first support 30 and the covering unit 301, which are the first members, are members different from each other. Specifically, the accommodation unit 303a accommodates the magnetic member 152 and the covering unit 301. For example, the covering unit 301 is a plate-like member having an area larger than that of the lower surface 152a of the magnetic member 152. For example, the covering unit 301 covers substantially the entire lower surface 152a of the magnetic member 152. For example, the covering unit 301 may be fixed to the first support 30 using a fixing tool such as a screw.

Other structures and effects of the second modification are similar to those of the embodiment in FIGS. 1 to 13.

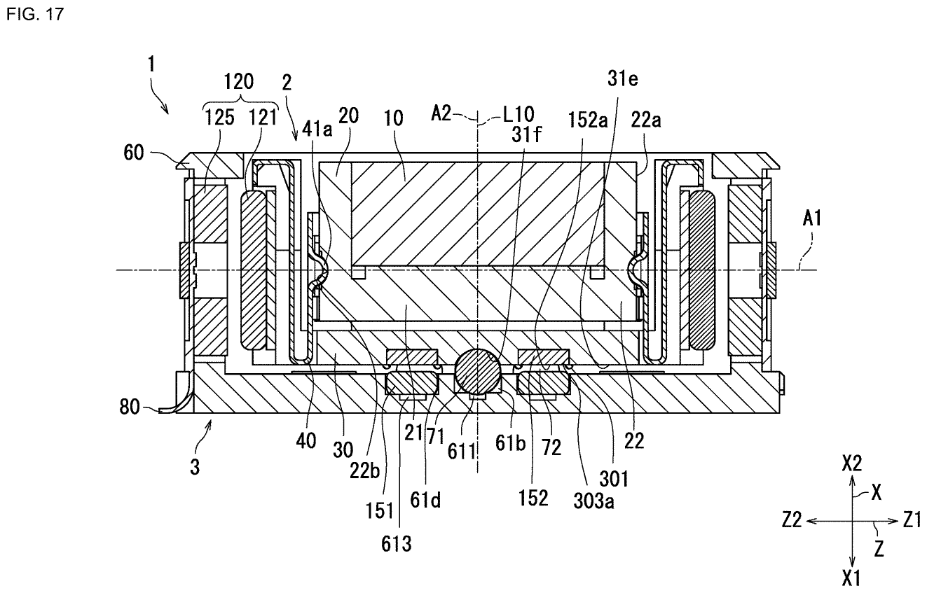

With reference to FIG. 17, the third modification of the embodiment of the present disclosure will be described. FIG. 17 is a sectional view illustrating the structure of the optical unit 1 according to the third modification of the embodiment. In the third modification, unlike the second modification in FIG. 16, an example in which the covering unit 301 is formed of a coating agent will be described.

As illustrated in FIG. 17, the first support 30 and the covering unit 301, which are the first members, are different from each other. Specifically, for example, the covering unit 301 is made of a coating agent. For example, the covering unit 301 covers the entire area of the contours (edges) of the lower surface 152a of the magnetic member 152. For example, the covering unit 301 may cover the entire lower surface 152a of the magnetic member 152. In FIG. 17, although the accommodation unit 303a is illustrated in a shape different from the shape in FIG. 16, the accommodation unit 303a may have the same shape as the shape in FIG. 16.

Other structures and effects of the third modification are similar to those of the second modification.

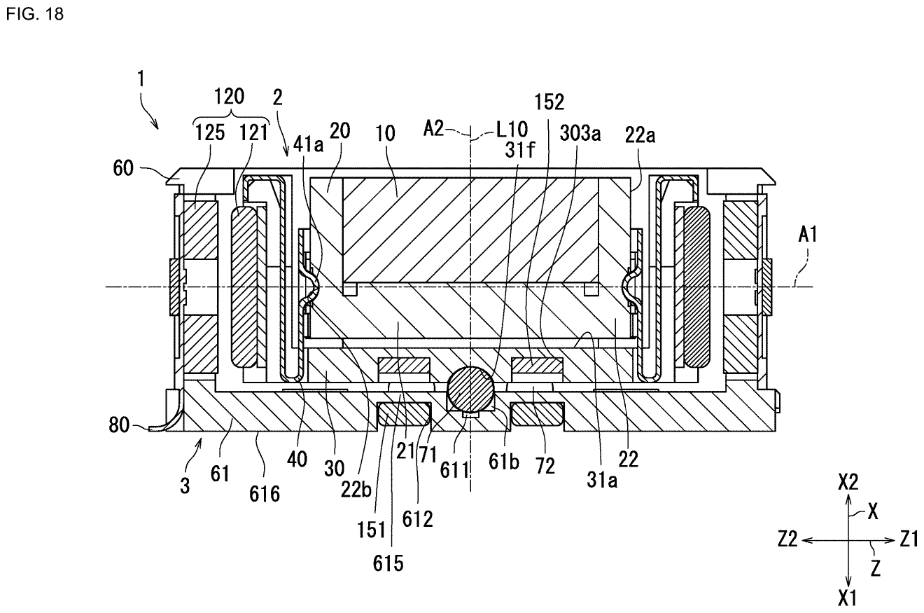

With reference to FIG. 18, the fourth modification of the embodiment of the present disclosure will be described. FIG. 18 is a sectional view illustrating the structure of the optical unit 1 according to the fourth modification of the embodiment. In the fourth modification, unlike the embodiment in FIGS. 1 to 13, an example in which a covering unit 615 is disposed on the support body 3 will be described.

As illustrated in FIG. 18, in the fourth modification, the support body 3 includes the support main body 61 including an accommodation unit 612 in which one of the magnet 151 and the magnetic member 152 is disposed. The support main body 61 is an example of the “first member” of the present disclosure. In the fourth modification, the support body 3 includes the support main body 61 including the accommodation unit 612 in which the magnet 151 is disposed, and the covering unit 615. In addition, the support main body 61 includes the opposite surface (hereinafter, sometimes referred to as a lower surface 616) facing the side opposite to the movable body 2. That is, in the fourth modification, the support main body 61 includes the lower surface 616 facing one side X1 in the first direction X at a position opposite to the opposing surface 61a in the first direction X. The accommodation unit 612 is disposed on the lower surface 616.

The magnet 151 is fitted in the accommodation unit 612. Accordingly, the magnet 151 is fixed to the accommodation unit 612. For example, the magnet 151 is fixed to the accommodation unit 612 by an adhesive or press-fitting.

For example, the accommodation unit 612 may have a structure in which the accommodation unit 303a in FIG. 5C is reversed in the first direction X. In addition, the accommodation unit 612 may have a structure in which the accommodation units 303a of the first to third modifications are reversed in the first direction X.

In addition, for example, the accommodation unit 303a of the movable body 2 may have a structure similar to that in FIG. 5C. In addition, the accommodation unit 303a may have the same structures as the first to third modifications. In addition, the accommodation unit 303a may have the structure in FIG. 18. In this case, for example, the magnetic member 152 may be fixed to the accommodation unit 303a by an adhesive or press-fitting.

Other structures and effects of the fourth modification are similar to those of the embodiment in FIGS. 1 to 13.

The embodiment (including modifications) of the present disclosure has been described above with reference to the drawings. However, the present disclosure is not limited to the above-described embodiment, and can be implemented in various modes without departing from a gist thereof. Various disclosures can be formed by appropriately combining the plurality of components disclosed in the above embodiment. For example, some components may be removed from all components illustrated in the embodiment. For example, constituent elements described in different embodiments may be appropriately combined. The components in the drawings are mainly and schematically illustrated for facilitating better understanding, and the thickness, length, number, interval, and the like of each illustrated component may be different from reality for the convenience of creating drawings. The material, shape, dimensions, and the like of each component described in the above embodiment are merely examples and are not particularly limited, and various modifications can be made without substantially departing from the effects of the present disclosure.

For example, in the above-described embodiment, the example in which the magnetic member 152 is disposed on the movable body 2 while the magnet 151 is disposed on the support body 3 has been described. However, the present disclosure is not limited thereto. For example, the magnetic member 152 may be disposed on the support body 3, and the magnet 151 may be disposed on the movable body 2.

Furthermore, in the above-described embodiment, the example in which the entire magnetic member 152 is disposed inside the accommodation unit 303a has been described. However, the present disclosure is not limited thereto. A part of the magnetic member 152 may be disposed inside the accommodation unit 303a.

Furthermore, in the above-described embodiment, the example in which the magnet 151 and the magnetic member 152 are disposed so as to overlap each other as viewed from the direction in which the support body 3 supports the movable body 2 has been described. However, the present disclosure is not limited thereto. The magnet 151 and the magnetic member 152 may be disposed so as to overlap each other as viewed from the direction intersecting the direction in which the support body 3 supports the movable body 2.

Furthermore, in the above-described embodiment, the example in which the support body 3 supports the movable body 2 in the direction (first direction X) along the direction in which the light L enters the optical element 10 has been described. However, the present disclosure is not limited thereto. For example, the support body 3 may support the movable body 2 in the direction (second direction Y) along the direction in which the light L exits from the optical element 10. Furthermore, the support body 3 may support the movable body 2 in the direction (third direction Z) intersecting the direction in which the light L enters the optical element 10 and the direction in which the light L exits from the optical element 10.

Furthermore, for example, in the above-described embodiment, the example in which the covering unit 301 covers the entire region of the contour of the magnetic member 152 has been described. However, the present disclosure is not limited thereto. For example, the covering unit 301 may cover a part of the contour of the magnetic member 152. In this case, for example, a plurality of covering units 301 covering the contour of the magnetic member 152 at equal intervals may be disposed.

In the above-described embodiment, the example in which the magnetic member 152 is made of the magnetic material is illustrated. However, the present disclosure is not limited to this. For example, the magnetic member 152 may be a magnet.

For example, the present disclosure can be used in the optical unit and the method for manufacturing the optical unit.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical unit comprising:
a movable body that includes an optical element that changes a traveling direction of light;
a support body that supports the movable body swingably about a swing axis;
a swing mechanism that swings the movable body about the swing axis;
a magnet disposed on one of the movable body and the support body; and
a magnetic member disposed on the other of the movable body and the support body,
wherein the magnet and the magnetic member overlap each other,
at least one of the movable body and the support body includes a covering unit disposed between the magnet and the magnetic member, and
the covering unit covers at least a part of a contour of one of the magnet and the magnetic member.

2. The optical unit according to claim 1, wherein
at least one of the movable body and the support body includes a first member including an accommodation unit in which one of the magnet and the magnetic member is disposed, and the covering unit, and
the first member and the covering unit are a single member.

3. The optical unit according to claim 2, wherein
the first member includes an opposite surface facing a side opposite to at least the other of the movable body and the support body, and
the accommodation unit is recessed from the opposite surface toward at least the other of the movable body and the support body.

4. The optical unit according to claim 1, wherein
at least one of the movable body and the support body includes a first member including an accommodation unit in which one of the magnet and the magnetic member is disposed, and the covering unit, and
the first member and the covering unit are different members.

5. The optical unit according to claim 1, wherein one of the magnet and the magnetic member is entirely disposed inside at least one of the movable body and the support body.

6. The optical unit according to claim 5, wherein
at least one of the movable body and the support body includes a first member including an accommodation unit in which one of the magnet and the magnetic member is disposed, and the covering unit, and
the magnetic member is disposed in the accommodation unit.

7. The optical unit according to claim 1, wherein the magnet and the magnetic member overlap each other as viewed from a direction in which the support body supports the movable body.

8. The optical unit according to claim 1, wherein
the optical element reflects light traveling to one side in a first direction to one side in a second direction intersecting the first direction, and
the support body supports the movable body in the first direction.

9. The optical unit according to claim 8, further comprising a plurality of the magnets and a plurality of the magnetic members,
wherein each of the magnet and the magnetic member is disposed symmetrically about the swing axis in a third direction intersecting the first direction and the second direction.

10. The optical unit according to claim 1, wherein
the swing mechanism includes:
a swing magnet disposed on the movable body or the support body; and
a swing coil disposed on the support body or the movable body.

11. A method for manufacturing an optical unit including:
a movable body that includes an optical element that changes a traveling direction of light, a support body that supports the movable body so as to be swingable about a swing axis;
a swing mechanism that swings the movable body about the swing axis;
a magnet disposed on one of the movable body and the support body; and
a magnetic member disposed on the other of the movable body and the support body,
the magnet and the magnetic member overlapping each other,
the optical unit manufacturing method comprising:
a step of disposing the magnet or the magnetic member in a mold;
a step of injecting resin into the mold to mold at least one of the movable body and the support body; and
a step of causing the support body to support the movable body,
wherein in the molding step, at least one of the movable body and the support body includes a covering unit that covers at least apart of a contour of the magnet and the magnetic member, and
in the supporting step, the covering unit is disposed between the magnet and the magnetic member.
